(19) United States
(12) Patent Application Publication
(10) Pub. No.: US 2003/0189888 A1
(43) Pub. Date: Oct. 9, 2003

(54) Data read/write method for the laser head of the lower inertial compact disk driving device

(76) Inventor: Chien-Tzu Hou, Fremont, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/117,201

(22) Filed: Apr. 8, 2002

(51) Int. Cl. G11B 7/135

(52) U.S. Cl. 369/112.29

(57) ABSTRACT

A data read/write method for the laser head of the lower inertial compact disk driving device, which includes a rotary needle, an compact composition, and a tracking device, wherein the compact composition, constructed on the rotary needle, transmits the laser beam towards and backwards between the disk and the laser head by the revolution of the rotary needle as well as the back and forth straight movements of the tracking device. The compact composition is composed of a movable reflector and a fixed reflector to form a read/write compact path. The laser beam is firstly reflected to the horizontal beam via the fixed reflector, then reflected to the perpendicular beam via the movable reflector to one track on the disk; and the beam, reflected back along the original path from the reflection layer of the compact disk, is received by the laser head. Thus, by switching the reading and writing position of the rotary needle and the tracking device, a data read/write method for the compact disk driving device with a stationary disk and laser head is accomplished.

### BACKGROUND OF THE INVENTION

1. Field of the Invention

The present invention relates to a data read/write method for the laser head of the lower inertial compact disk driving device, in particular, with a stationary disk and laser head, a data read/write method by switching the reading and writing position of the rotary needle and the tracking device.

2. Related Art

The compact disk driving device is one of the popular storage apparatuses. Depending on the applications, there are three types: the read only memory, the write once drive apparatus, and the erasable rewrite drive apparatus. No matter which type, is basically composed of the laser head, the optical system, the serve system, the accurate machinery, the electric circuit, and the control circuit, etc. In the present technologies, when operating reading and writing, the compact disk driving device adapts revolving the disk as well as moving the laser head and which additional components straightly back and forth. Due to the respectively large mass of the laser head and which additional components moving back and forth frequently while operating, and even more, the revolution inertia of the high-speed revolving disk is large, thus causes big vibration and high energy waste when the present compact disk driving device operates reading and writing.

With adapting many new technologies, the ability of the compact disk driving device is improved continuously. However, the present compact disk driving devices all adapt moving the laser head back and forth, and revolving the disk in high speed. For the respectively large mass and revolution inertia of the disk, and even the large mass of the laser head and which additional devices, the present compact disk driving devices have defects as high energy waste, big vibration during operation, much heat produced, thus limits the applications of the compact disk driving device. As for the technology of the present compact disk driving device cannot be applied in PDA (Personal Digital Assistant). The portable instrument as PDA contains functions such as calculator, phone, fax, and Internet connection etc, which can be accomplished with wireless technology. The outer extent requirements of PDA must be low energy waste, without releasing overheat. However, the current compact disk driving devices, due to the limitations as the respectively large mass of the laser head and the large revolution inertia of the high-speed revolving disk, low energy waste and low heat release is impossible to be accomplished.

### SUMMARY OF THE INVENTION

Thus, the main achievement of the present invention is providing a data read/write method for the laser head of the lower inertial compact disk driving device, in particular, a data read/write method for maintaining the laser head and the disk stationary when the laser head operates reading and writing.

According to above mentions, the lower inertial compact disk driving device includes a rotary needle, an compact composition, and a tracking device, wherein the compact composition, constructed on the rotary needle, transmits the laser beam towards and backwards between the disk and the laser head by the revolution of the rotary needle as well as the back and forth straight movements of the tracking device. The compact composition is composed of a movable reflector and a fixed reflector to form a read/write compact path. The laser beam is firstly reflected to the horizontal beam via the fixed reflector, then reflected to the perpendicular beam via the movable reflector to one track on the disk; and the beam, reflected back along the original path from the reflection layer of the compact disk, is received by the laser head. Thus, by switching the reading and writing position of the rotary needle and the tracking device, a data read/write method for the compact disk driving device with a stationary disk and laser head is accomplished.

According to above mentions, for the low revolution inertia of the rotary needle of the invention, the rotary needle can be driven by the low power motor. Similarly, for the little mass of the compact composition, the tracking device can also be driven by the low power motor. Thus, the disadvantage factors as high energy waste, much heat release, vibrations, and noise can be discarded.

The foregoing and many other aspects of the present invention will no doubt become obvious to those of ordinary skill in the art after having read the following detailed description of the preferred embodiments that are illustrated in the various drawing figures.

### BRIEF DESCRIPTION OF THE DRAWINGS

FIG. 1 illustrates the data read/write compact path of the present invention;

FIG. 2 illustrates the movement for the movable reflector in the disclosed data read/write method of the present invention;

FIG. 3 illustrates an embodiment of the present invention;

FIG. 4 illustrates the profile of the rotary needle in FIG. 3;

FIG. 5 illustrates the vertical view of the rotary needle in FIG. 3;

FIG. 6 illustrates the profile of the tracking device in FIG. 3;

FIG. 7 illustrates the vertical view of the tracking device in FIG. 3; and

FIG. 8 illustrates the construction of the disk fastening device in FIG. 3.

### DETAILED DESCRIPTION OF THE PREFERRED EMBODIMENT

A disk 10 described in the invention is the document storage medium of a computer, includes document systems as ISO-9660, Joliet, and Romeo, etc.

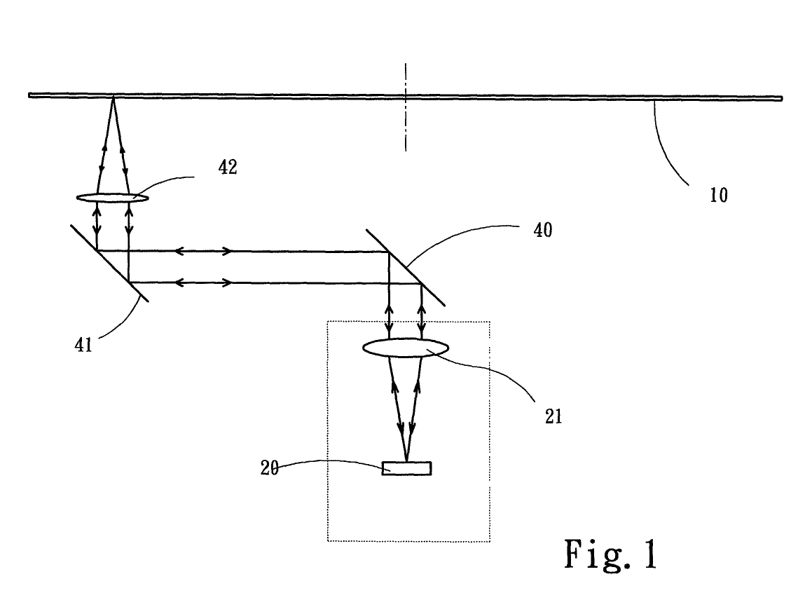

As shown in FIG. 1, the disclosed data read/write method for the laser head is a method as when the compact disk drive operates reading and writing, the horizontally placed disk 10 maintains still, and the laser beams emitted from a perpendicularly located laser head 20, firstly refract to parallel beams via a convex lens 21, then reflect to horizontal beams via a fixed reflector 40, still then reflect to perpendicular beams via a movable reflector 41, and then converge on one track of the disk 10. Similarly, the beams reflected from the reflection layer of the disk 10 transmitting sequentially via a convergent lens 42, the movable reflector 41, the fixed reflector 40, and the convex lens 21, are finally received and operated by the laser head 20. When reading and writing the data at different locations on the disk 10, the movable reflector 41 and the fixed reflector 40 revolve round the central axis of the disk 10, and with one constant relative angle, the movable reflector 41 can be synchronously moved back and forth in the radius route of the disk 10 to read and write the data at different locations on the disk 10.

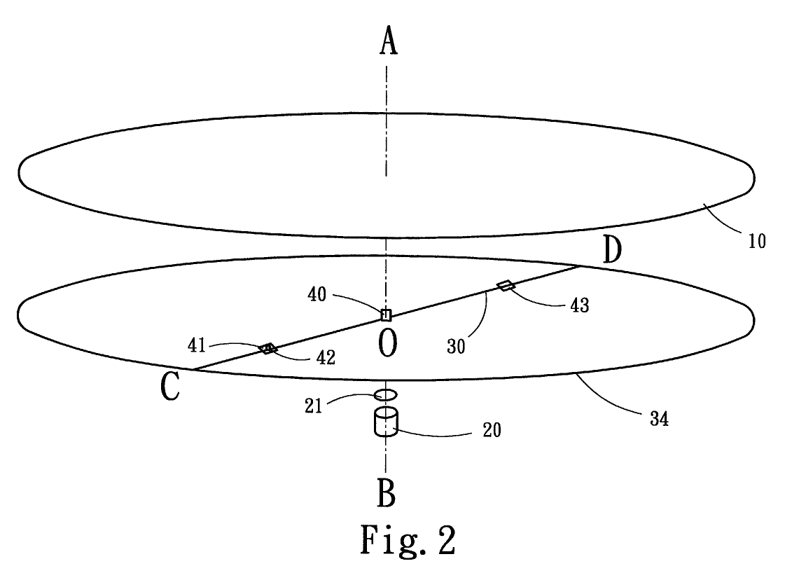

As shown in FIG. 2, the above-mentioned convergent lens 42, combining with the movable reflector 41, can be moved in the C-D axis on a rotary needle 30 (as detailed descriptions as follows); the fixed reflector 40, assembled on the rotary needle 30, revolves together with the rotary needle 30; a balance block 43, assembled on the other side of the rotary needle 30 opposite to the movable reflector 41, can be moved similarly in the C-D axis on the rotary needle 30. The rotary needle 30 revolves round the A-B axis, and carries the convergent lens 42, the movable reflector 41, the fixed reflector 40 and the balance block 43, which are all assembled on the rotary needle 30, revolving together. When revolving, the movable reflector 41, the convergent lens 42 and the balance block 43 also move synchronously and oppositely straight along the C-D axis, wherein the movable reflector 41 moves within O-C route, while the balance block 43 moves within O-D route to keep balance.

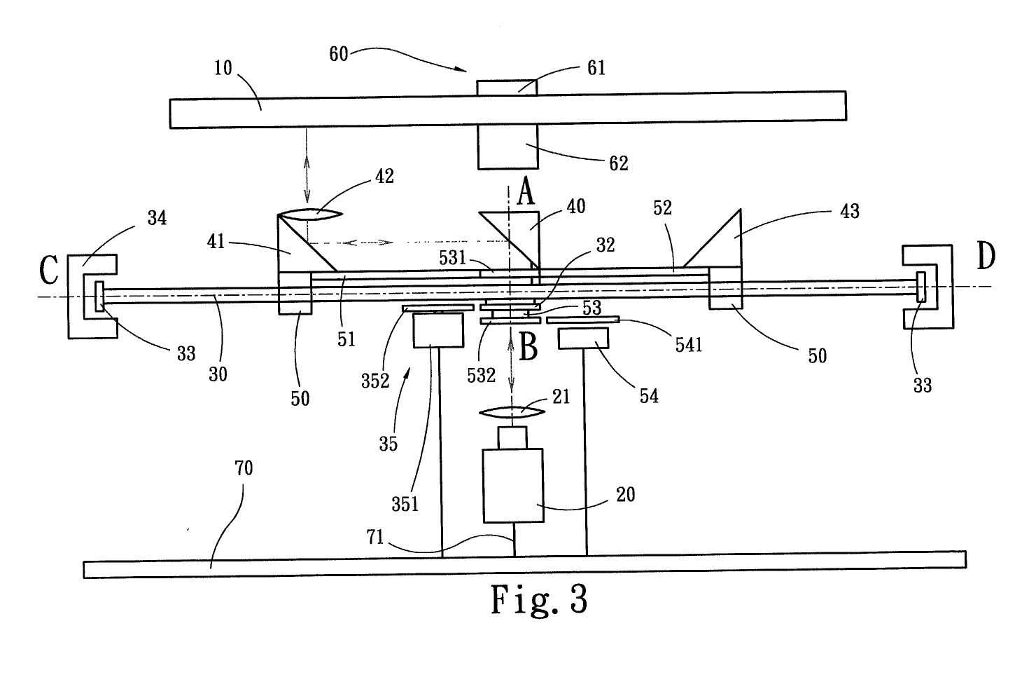

As shown in FIG. 3, a preferred embodiment illustration of the disclosed data read/write method applied by the designed lower inertial compact disk driving device of the invention; wherein the lower inertial compact disk driving device includes:

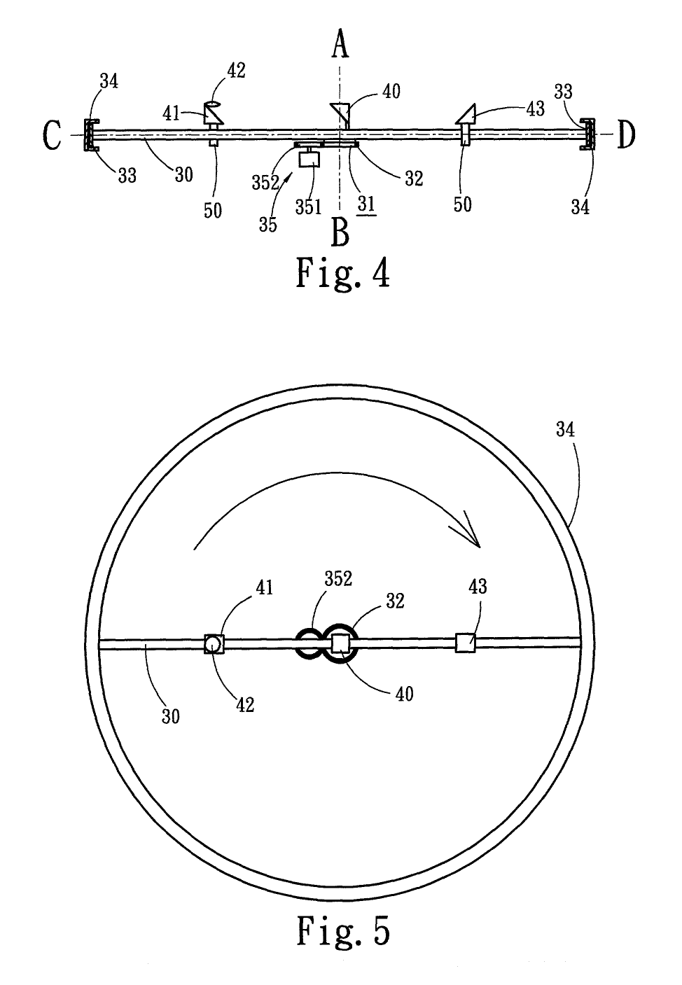

The rotary needle 30, as shown in FIG. 4 and FIG. 5, is assembled underneath the read/write surface of the disk 10. An aperture 31 is assembled in the center of the disk, and a gear 32 combined together with the rotary needle 30 is prominently assembled underneath the aperture 31, wherein the center of the gear 32 overlaps the center of the rotary needle 30 and carries the rotary needle 30 revolving.

On both ends of the rotary needle 30 are respectively assembled a light suspension wheel 33, which can continuously revolve round the sidelong central axis C-D of the rotary needle 30. While revolving, the light suspension wheels 33 contacts with the inner wall of an annular position-limiting device 34, which maintains still to prevent the vibration due to the high speed revolution of the rotary needle 30, and keep the rotary needle 30 within the appropriate deflection displacement.

A revolution drive device 35, is composed of a drive motor 351 combining with a gear 352, which joints to the above-mentioned gear 32; wherein the drive motor 351 directly revolves the gear 352, and caries the gear 32 revolving, to make the rotary needle 30 continuously revolve round the central A-B axis.

An compact composition, which provides as the transmitting component for the emitting beams from the laser head 20, includes:

The fixed reflector 40, fixedly assembled in the center of the rotary needle 30, provides for reflecting the laser beams to the movable reflector 41, or to the laser head 20.

The movable reflector 41 and outside which the convergent lens 42 assembled with the appropriate angle, provide for converging the laser beams reflected from the movable reflector 41 to the disk 10, or transmitting the beams reflected back from the disk 10 to the fixed reflector 40.

The balance block 43, assembled on the other side of the rotary needle 30 opposite to the movable reflector 41, provides for maintaining balance for the rotary needle 30.

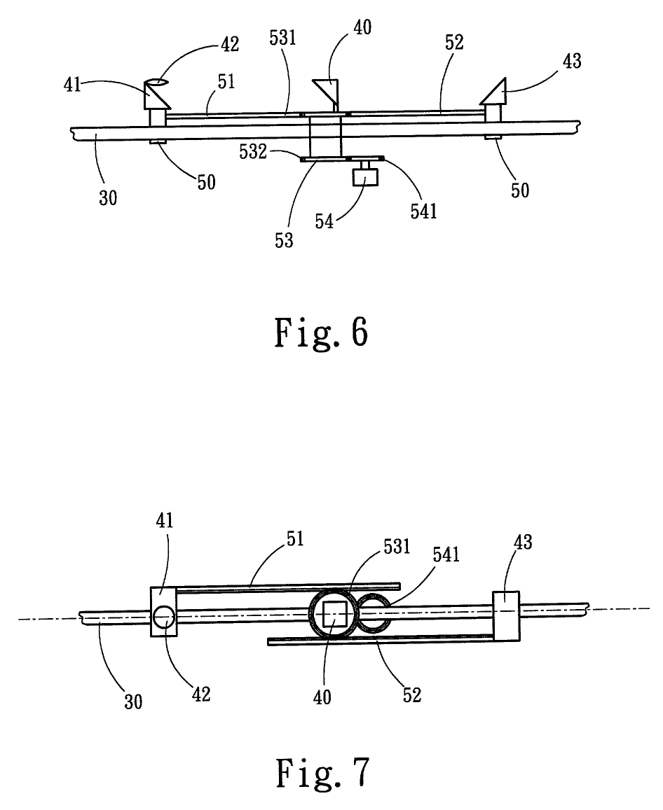

A tracking device, as shown in FIG. 6 and FIG. 7, includes:

Two movable plates 50 provide as the bases for the movable reflector 41 and the balance block 43. A gear rack 51, 52 are respectively assembled on each lateral of the movable reflector 41 and the balance block 43.

A cannular drive component 53, on both upper side and underside respectively assembled a gear 531, 532; wherein the upper gear 531 joints to the above-mentioned gear track 51, 52.

A servo motor 54, combined with a gear 541, which joints to the underside gear 532 of the cannular drive component 53, provides for carrying the movable reflector 41 and the balance block 43 oppositely moving straight back and forth.

The servo motor 54 drives the gear 541 and carries the underside gear 532 of the cannular drive component 53 revolving, and carries the upper gear 531 revolving to move the gear rack 51, 52, thus changes the revolution movements to the opposite straight movements. So, the movable reflector 41, the convergent lens 42 and the balance block 43 are synchronously driven to move oppositely straight back and forth in the C-D route, that is, the balance block 43 moves in the opposite direction to the movable reflector 41 in order to maintain balance throughout for the rotary needle 30, thus maintains the dynamic balance for the whole revolving device when the rotary needle 30 revolves in high speed; owing to being fixedly assembled in the center of the rotary needle 30, the fixed reflector 40 revolves in high speed with the rotary needle 30, and maintains the relative angle constant to the movable reflector 41.

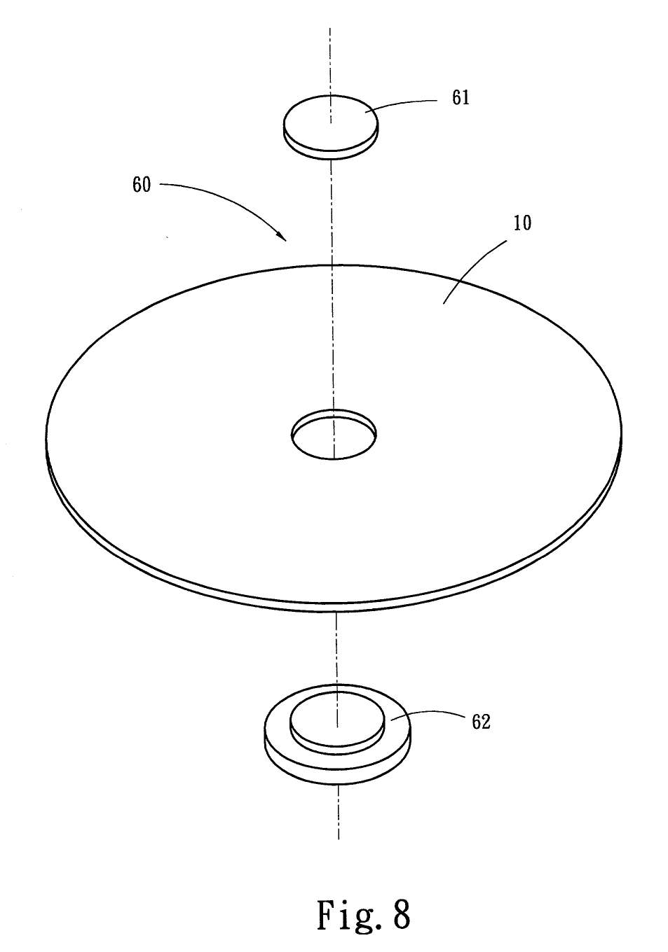

Detailed descriptions are as follows: as above mentions, the disk 10 maintains still for being fastened by a disk fastening device 60 as shown in FIG. 8, wherein the disk fastening device 60 is composed of a disk installation upward pressure device 61 and a disk base 62. The disk 10 is placed on the disk base 62 with the read/write surface downwards, and tightly compressed onto the disk base 62 with the disk installation upward pressure device 61, for ensuring to keep the disk 10 from revolving.

When the compact disk drive of the presented invention operates, the rotary needle 30 is carried by the revolution drive device 35, and thus makes the mutually-jointed gear 32 and the gear 352 revolve round the central A-B axis in high speed. While the rotary needle 30 revolves in high speed, the compact composition and the tracking device also revolve in high speed together with the rotary needle 30; in the meantime, the movable reflector 41 and the balance block 43 move oppositely toward left and right (along the C-D route) on the rotary needle 30, that is, the movable reflector 41 moves within O-C route, while the balance block 43 moves within O-D route, and thus maintains balance for the whole revolving device the fixed reflector 40 revolves synchronously in high speed only with the rotary needle 30 to maintain the constant relative angle, thus the beams emitted from the laser head firstly reflect from the fixed reflector 40 to the movable reflector 41, and converges on one track of the disk 10 via the convergent lens 42; all beams reflected back from the reflection layer of the disk 10 are received by the laser head 20 after sequentially passing through the convergent lens 42, the movable reflector 41 and the fixed reflector 40. That is, when the rotary needle 30 revolves in high speed, as well as the movable reflector 41, the convergent lens 42 and the balance block 43 move straight back and forth, the injecting angle for the emitted beams injected from the laser head 20 to the fixed reflected 40 maintains constant; similarly, the injecting angle for the reflected beams reflect from the fixed reflected 40 to the movable reflector 41 also maintains constant; all beams reflected back from the reflection layer of the disk 10 are received by the laser head 20 via the original compact path, and then transmit via a data transmission line 71, then to be operated by a control circuit 70.

Moreover, when the gear 32 and 352 carry the rotary needle 30 revolving in high speed, the gear 32 matches the gap of the gear 352, and the friction between both of them is small enough not to influence the cannular driving component 53 assembled concentrically with the gear 32. Thus, the revolution of the gear 32 is not influenced, when the gear 531 carries the movable reflector 41 and the balance block 43.

The disclosed data read/write method for the laser head, applies the back and forth straight movements of the movable reflector 41 and the convergent lens 42 to substitute the back and forth straight movements of the laser head 20, and applies the revolution of the rotary needle 30 to substitute the revolution of the disk 10. In the reading and writing processes, the laser head 20 is able to project to every position on the high-speed revolving disk 10. Thus, by the disclosed method, the operation of the present disk drive as with the laser head 20 and other additional components move straight back and forth, and with the disk 10 revolves in high speed, is improved. Furthermore, the electronic path controlling movements of the movable reflector 41 is adapted with the electronic path controlling back and forth movements of the laser head 20 and other additional components in present technology. Similarly, the electronic path controlling the revolution of the rotary needle 30 is adapted with the electronic path controlling the revolution of the disk 10 in present technology. So, there is no necessary to develop new controlling electric path, thus greatly decreases the manufacturing cost.

As the conclusion of the above mentions, the disclosed data read/write method for the laser head of the lower inertial compact disk drive, provides effective solving manners and strategies to the loss such as producing high inertia, high energy waste, high heat, etc. for the traditional compact disk drive revolving the disk and moving the laser head and other additional units straight back and forth.

As previously stated, detailed embodiments of the present invention are disclosed herein, however, it is to be understood that the disclosed embodiments are merely exemplary of the invention that may be embodied in various forms. These and other variations, which will be understood by those skilled in the art, are within the intended scope of the invention as claimed below.

What is claimed is:

1. A data read/write method for the laser head of the lower inertial compact disk driving device, relates to maintain the disk and the laser head stationary, transmits laser beams by an compact composition and switches a rotary needle and a tracking device for different reading and writing positions, wherein the compact composition composes of a fixed reflector and a movable reflector assembled underneath the rotary needle, and forms the compact path as follows:
(a) beams emitted from the laser head are reflected to perpendicular beams via the movable reflector;
(b) horizontal beams transmitted via the fixed reflector are reflected to perpendicular beams by the movable reflector, and are projected to the disk;
(c) perpendicular beams reflected back from the reflection layer of the disk are reflected to horizontal beams by the movable reflector;
(d) horizontal beams transmitted via the movable reflector are reflected to perpendicular beams by the fixed reflector, and are received by the laser head..

2. The data read/write method for the laser head of the lower inertial compact disk driving device of claim 1, wherein said rotary needle carries the compact composition revolving for switching laser beams projecting to different reading and writing positions in the same track on the disk..

3. The data read/write method for the laser head of the lower inertial compact disk driving device of claim 1, wherein said tracking device carries the compact composition moving straight on the rotary needle for switching laser beams projecting to different tracks within the radius range on the disk.

4. The data read/write method for the laser head of the lower inertial compact disk driving device of claim 1, wherein a balance block is assembled on the opposite side to the movable reflector on the rotary needle for maintaining dynamic balance when revolving.

5. The data read/write method for the laser head of the lower inertial compact disk driving device of claim 1, wherein said balance block synchronously moves straight with the movable reflector oppositely.

6. The data read/write method for the laser head of the lower inertial compact disk driving device of claim 1, wherein a convergent lens is assembled outside the movable reflector for converging the laser beams on the disk.

7. The data read/write method for the laser head of the lower inertial compact disk driving device of claim 1, wherein said fixed reflector revolves synchronously with the rotary needle.

8. The data read/write method for the laser head of the lower inertial compact disk driving device of claim 1, wherein said compact path (a) relates to the laser beams emitted from the laser head firstly refract to parallel beams via a convex lens..

9. The data read/write method for the laser head of the lower inertial compact disk driving device of claim 1, wherein said compact path (a) relates to maintaining the injecting angle constant for the laser beams emitted from the laser head inject to the fixed reflector.

10. The data read/write method for the laser head of the lower inertial compact disk driving device of claim 1, wherein said compact path (b) relates to maintaining the injecting angle constant for the laser beams reflecting from the fixed reflector inject to the movable reflector.
